(19) United States
(12) Patent Application Publication
(10) Pub. No.: US 2008/0023545 A1
(43) Pub. Date: Jan. 31, 2008

(54) LENS MODULE

(75) Inventors: CHEN FENG, Snohomish, WA (US); MING LEE, Chu-Nan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Chu-Nan (TW)

(21) Appl. No.: 11/616,832

(22) Filed: Dec. 27, 2006

(30) Foreign Application Priority Data
Jul. 28, 2006 (CN) 200610061869.2

(51) Int. Cl. G06K 7/10

(52) U.S. Cl. 235/454; 235/462.41

(57) ABSTRACT

A lens module (200) includes a barrel (20), at least one lens (30) and an image sensing module (40). The lens received in the barrel. The image sensing module is mounted on a mounting end of the barrel and includes an image sensor (41), a top board (42), a carrier with a base board (43), and a filtering film (44). The image sensor is mounted on the base board. The top board is mounted on the carrier to enclose the image sensor. The filtering film is mounted on a surface of the top board.

### BACKGROUND OF THE INVENTION

1. Field of the Invention

The present invention generally relates to lens modules and, more particularly, to a lens module for an optical device such as a microscope, a camera module, a digital camera module used in a portable electronic device, etc.

2. Description of Related Art

With the ongoing development of microcircuitry and multimedia technologies, digital cameras are now in widespread use. High-end portable electronic devices, such as mobile phones and personal digital assistants (PDAs), are being developed to be increasingly multi-functional. Many of these portable electronic devices are now equipped with a digital camera module. These electronic devices enable consumers to enjoy capturing digital pictures anytime and anywhere. At the same time, the need for digital picture quality has become greater and greater.

In a digital camera, a lens module is very important to determine the quality of the pictures captured by the digital camera. Referring to FIG. 4, a typical lens module 100 includes a lens group 12, a barrel 14 and an image sensing module 16. The lens group 12 includes a lens 121 for forming an optical image in the image sensing module 16 and an infrared-cut (IR-cut) filter 122 for reducing the amount of infrared light that reaches the image sensing module 16. The barrel 14 is a hollow cylinder, the lens group 12 is mounted in the barrel 14.

The image sensing module 16 includes an image sensor 161, a top board 162 and a base board 163. The image sensor 161 is mounted on the base board 163. The top board 162 is made of transparent materials such as glass or plastics. A periphery of the top board 162 is mounted on a periphery of the base board 163, thus the image sensor 161 is packaged between the top board 162 and the base board 163.

In assembly, the image sensing module 16 is attached to an end of the barrel 12, the image sensor 161 is located on a light-path of the lens group 12, and the top board 162 is disposed between the lens group 12 and the image sensor 161. In use, light enters the barrel 12, and is focused by the lens 121 and filtered by the IR-cut filter 122, and then runs through the top board 162 to reach the image sensor 161. The image sensor 161 receives the optical image signals and transforms the optical image signals into electronic image signals.

Generally, besides the top board 162, the lens 121 and the IR-cut filter 122 of the typical lens module 100 are also made of glass or plastics. The lens 121, the IR-cut filter 122 and the top board 162 each has high weight and volume, therefore the lens module 100 has a relative large volume and weight, and manufacturing of the lens module 100 costs more material.

Therefore, an improved lens module is desired in order to overcome the above-described shortcomings.

### SUMMARY OF THE INVENTION

In a preferred embodiment thereof, a lens module includes a barrel, at least one lens and an image sensing module. The lens received in the barrel. The image sensing module is mounted on a mounting end of the barrel and includes an image sensor, a top board, a carrier with a base board, and a filtering film. The image sensor is mounted on the base board. The top board is mounted on the carrier to enclose the image sensor. The filtering film is mounted on a surface of the top board.

Other advantages and novel features will become more apparent from the following detailed description when taken in conjunction with the accompanying drawings.

### BRIEF DESCRIPTION OF THE DRAWINGS

Many aspects of the lens module can be better understood with reference to the following drawings. The components in the drawings are not necessarily drawn to scale, the emphasis instead being placed upon clearly illustrating the principles of the lens module. Moreover, in the drawings, like reference numerals designate corresponding parts through out the several views.

FIG. 1 is schematic, cross-sectional view of a lens module in accordance with a first preferred embodiment of the present invention;

FIG. 2 is a schematic, cross-sectional view of a lens module in accordance with a second preferred embodiment of the present invention;

FIG. 3 a schematic, cross-sectional view of a lens module in accordance with a third preferred embodiment of the present invention; and

FIG. 4 is a schematic, cross-sectional view of a typical lens module.

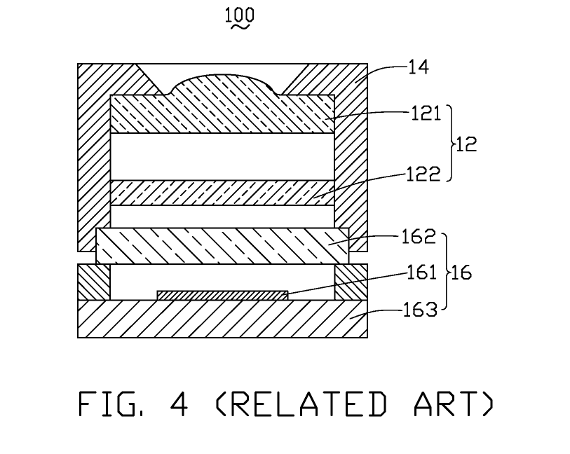

### DETAILED DESCRIPTION OF THE INVENTION

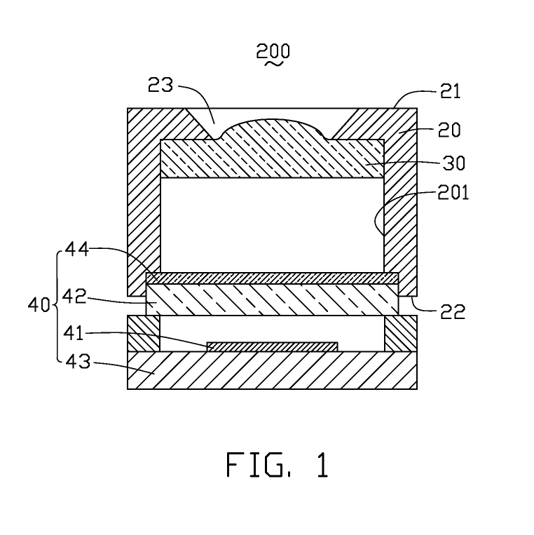

Referring now to the drawings in detail, FIG. 1 shows a lens module 200 in accordance with a first preferred embodiment of the present invention. The lens module 200 includes a barrel 20, a lens 30 and an image sensing module 40. The lens 30 is received in the barrel 20. The image sensing module 40 is mounted on an end of the barrel 20.

The barrel 20 is a hollow cylinder in shape and the barrel 20 includes an inner surface 201, a screening end 21 and a mounting end 22 positioned opposite to the screening end 21. The barrel 20 defines an aperture 23 at a central portion of the screening end 21. The lens 30 is mounted in the barrel 20 facing the aperture 23. Understandably, a plurality of lenses 30 can also be mounted in the barrel 20.

The image sensing module 40 includes an image sensor 41, a top board 42, a carrier (not labeled) having a base board 43 and a sidewall (not labeled) extending upward from a periphery of the base board 43, and a filtering film 44. The image sensor is mounted on the base board 43. The top board 42 is made of transparent material such as glass or plastic. A periphery of the top board 42 is mounted on the sidewall of the carrier to form a closed cavity, and the image sensor 41 is packaged within the cavity and mounted on the base board 43. The filtering film 44 is made of different kinds of oxide such as Ta₂O₅, TiO₂, SiO₂, etc., and the filtering film 44 can reduce infrared light transmitted therethrough. The filtering film 44 can be attached to glass by means of plating or gluing, thus the filtering film can be formed to have a thickness less than the IR-cut filter 122 used in typical lens modules. The filtering film 44 is applied to a top surface of the top board 42 between the lens 30 and the top board 42 by means of plating or gluing, thus the top board 42 is sandwiched between the filtering 44 and the base board 43.

In assembly, the image sensing module 40 is mounted on the mounting end 22 of the barrel 20. The filtering film 44, the top board 42 and the image sensor 41 are positioned in a line on a light-path of the lens 30. In use, light enters the lens barrel 20 via the aperture 23, and passes sequentially through the lens 30, the filtering film 44 and the top board 42, and finally reaches the image sensor 41 to form an object image thereon.

Understandably, the filtering film 44 is used in the lens module 200 to replace IR-cut filters in typical lens modules, thus weight and volume of the lens module 200 can be reduced since the filtering film 44 has a thickness less than the IR-cut filter 122 used in typical lens modules.

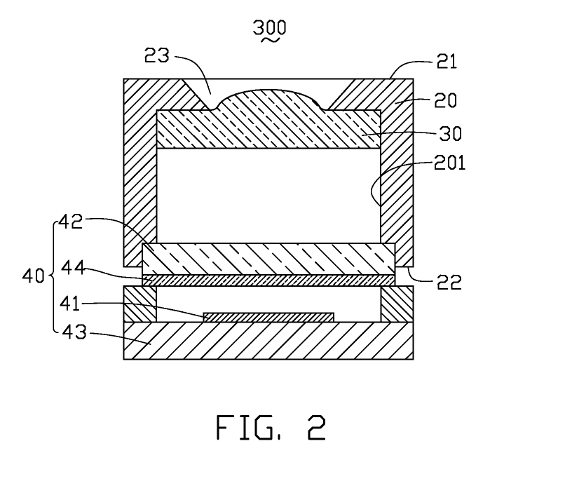

FIG. 2 shows a lens module 300 in accordance with a second preferred embodiment of the present invention. The components of the lens module 300 are similar to the components of the lens module 200. Assembly of the lens module 300 is basically similar to assembly of the lens module 200 except that the filtering film 44 is attached to a bottom surface of the top board 42, and the filtering film 44 is located between the top board 42 and the image sensor 41. In use, light enters the lens barrel 20 via the aperture 23, and sequentially passes through the lens 30, the top board 42 and the filtering film 44, and finally reaches the image sensor 41 to form an object image thereon.

Understandably, weight and volume of the lens module 300 can be reduced in a fashion similar to the lens module 200. Additionally, because the filtering film 44 is mounted between the top board 42 and the base board 43, the top board 42 of the lens module 300 can prevent the filtering film 44 from being contaminated by dust particles or water vapour.

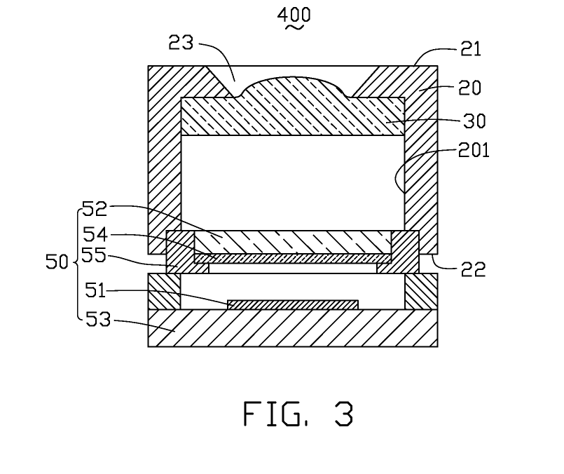

FIG. 3 shows a lens module 400 in accordance with a third embodiment of the present invention. The lens module 400 includes a barrel 20, a lens 30 and an image sensing module 50. The barrel 20 and the lens 30 have a structure similar to that of the barrel 20 and the lens 30 of the lens module 200 or the lens module 300. The image sensing module 50 includes an image sensor 51, a top board 52, a carrier (not labeled) having a base board 53 and a sidewall (not labeled) extending upward from a periphery of the base board 53 to form a cavity therebetween, a filtering film 54 and a connecting member 55.

The image sensor 51 is mounted on the base board 53. The top board 52 can be a lens or a plate made of transparent materials such as glass or plastic. The connecting member 55 is an annular component with a stepped hole (not labeled) defined in a central portion therethrough and a bottom flange adjacent the stepped hole. The top board 52 is received in the stepped hole of the connecting member 55. The connecting member 55 is mounted on the sidewall above the base board 53 to enclose the cavity, and the image sensor 51 is packaged within the cavity and mounted on the base board 53. The filtering film 54 is received in the stepped hole of the connecting member 55 and sandwiched between the top board 52 and the bottom flange of the connecting member 55.

In assembly, the image sensing module 50 is mounted on the mounting end 22 of the barrel 20, and the top board 52, the filtering film 54 and the image sensor 51 are located on a light-path of the lens 30 one by one. Use of the lens module 400 is similar to use of the lens module 300.

Understandably, weight and volume of the lens module 400 can be reduced similar to the lens module 200 and the lens module 300, and the filtering film can be protected. Additionally, in the lens module 400, the top board 52 is mounted on the carrier via the connecting member 55, which is more convenient compared to gluing or welding the inner surface of the top board 52 with the filtering film 54 to the carrier directly. Alternatively, the filtering film 54 can also be mounted an outside of the top board 52.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A lens module, comprising:
a barrel;
at least one lens received in the barrel; and
an image sensing module mounted on a mounting end of the barrel, the image sensing module comprising an image sensor, a top board, a carrier with a base board, and a filtering film, wherein the image sensor is mounted on the base board, the top board is mounted on the carrier to enclose the image sensor, and the filtering film is mounted on a surface of the top board.

2. The lens module as claimed in claim 1, wherein the barrel includes a screening end opposite to the mounting end, and the barrel defines an aperture in the screening end.

3. The lens module as claimed in claim 2, wherein the image sensor is located in a light-path of the lens.

4. The lens module as claimed in claim 1, wherein the top board is a transparent plate, the carrier further comprises a sidewall extending from a periphery of the base board, and a periphery of the top board is mounted on the sidewall.

5. The lens module as claimed in claim 1, wherein the top board is a lens, the carrier further comprises a sidewall extending from a periphery of the base board, and a periphery of the top board is mounted on the sidewall.

6. The lens module as claimed in claim 1, wherein the filtering film, the top board and the image sensor are positioned along a light-path of the lens in turn.

7. The lens module as claimed in claim 1, wherein the top board, the filtering film and the image sensor are positioned along a light-path of the lens in turn.

8. A lens module, comprising:
a barrel;
a lens received in the barrel; and
an image sensing module mounted on an end of the barrel, the image sensing module including an image sensor, a top board, a carrier having a base board, a filtering film and a connecting member, wherein the image sensor is mounted on the base board, the top board being mounted to the carrier via the connecting member to enclose the image sensor, and the filtering film is mounted to the top board.

9. The lens module as claimed in claim 8, wherein the top board is a transparent plate.

10. The lens module as claimed in claim 8, wherein the top board is a lens.

11. The lens module as claimed in claim 10, wherein a periphery of the top board is mounted on the connecting member, and the connecting member is mounted on a periphery of the base board.

12. The lens as module claimed in claim 8, wherein the top board, the filtering film and the image sensor are positioned along a light-path of the lens.

13. A lens module, comprising:
a barrel having a screening end with a lens mounted therein, and an opposite mounting end; and
an image sensing module mounted to the mounting end of the barrel, the image sensing module comprising a carrier having a base board and a sidewall extending from a periphery of the base board, an image sensor mounted on the base board and surrounded by the sidewall, a top board mounted to the sidewall to cooperatively enclose the image sensor in the carrier, a thin filtering film overlaid to the top board directly, wherein
the top board, the filtering film and the image sensor are positioned along a light-path of the lens.

14. The lens as module claimed in claim 13, wherein the top board and the filter are mounted in a hollow cylindrical connecting member opposite ends of which are respectively secured to the mounting end of the barrel and sidewall of the carrier.

15. The lens as module claimed in claim 13, wherein the filtering film is located between the top board and the image sensor.

16. The lens as module claimed in claim 13, wherein the filtering film is plated on a surface of the top board.
